(19) United States
(12) Patent Application Publication
(10) Pub. No.: US 2016/0224918 A1
(43) Pub. Date: Aug. 4, 2016

(54) BUSINESS INFLUENCED PART EXTRACTION METHOD AND BUSINESS INFLUENCED PART EXTRACTION DEVICE BASED ON BUSINESS VARIATION

(71) Applicant: Hitachi, Ltd., Tokyo (JP)

(72) Inventors: Masataka ARAKI, Tokyo (JP); Haruhiko NISHIYAMA, Tokyo (JP); Hideyuki KANUKA, Tokyo (JP); Yoshihiro KATAOKA, Tokyo (JP); Hidenori AZUSHIMA, Tokyo (JP); Shigeaki TAIRA, Tokyo (JP); Yasutaka HIRAYAMA, Tokyo (JP); Takahiro SHIGENO, Tokyo (JP)

(21) Appl. No.: 15/008,822

(22) Filed: Jan. 28, 2016

(30) Foreign Application Priority Data
Jan. 30, 2015 (JP) 2015-016322

(51) Int. Cl. G06Q 10/06

(52) U.S. Cl. CPC G06Q 10/06316

(57) ABSTRACT

The method and system include the following steps: storing in advance a logical relation between sets of business information used for a task in the business process, receiving a revision of the business process, extracting a difference between pre-revision business process information and post-revision business process information based on the pre-stored business process information, storing the difference information as revision history information of the business process to be revised, analyzing a processing category as a processing type of the business information of a pair of task and business information as constituent elements of the post-revision business process, storing the information in a storage device, extracting influenced business processes from the business process information based on an XOR relation between the sets of business information or an XOR relation of the series of tasks, receiving a selection of a business process among the influenced business processes, and displaying the results.

### TECHNICAL FIELD

The present invention relates to a business process design technique in enterprise information system development, and particularly relates to a method and a system capable of extracting other business processes that are influenced when a business designer revises a business process.

### BACKGROUND ART

A technique of expressing business requirements as business processes and implementing system design/development based on such business processes for attaining higher quality and efficiency in enterprise information system development is being adopted. A business process is a series of task groups that is structured for achieving a business purpose (creation, referral, update, or deletion of information to be utilized in a certain type of business), and expresses who will perform the task (business operation) in what order and by using which information.

Meanwhile, in enterprise information system development, business requirements are frequently changed due to changes in the business environment and modifications in the business operation. In order to prevent the reworking of subsequent processes in the course of implementing the system design/development based on business processes, it is important to efficiently and accurately revise the business process by following the changes in the business requirements, and maintain the accuracy of the business processes. Nevertheless, generally speaking, the revision of one business process will influence the other business processes. In particular, when dealing with large-scale and complicated business such as financial services, the business processes also become large-scale and complicated, and the other business processes are influenced considerably when one business process is revised. Thus, desired is a technique of accurately extracting the other business processes that may need to be revised (hereinafter referred to as the “influenced business processes”) when one business process is revised.

PTL 1 discloses a technique of searching for similar business processes with a certain business process as the search condition, and presenting business processes in ascending order from the most similar business process. Similarity is calculated based on the degree of coincidence of the task name, the actor name, and the task order configuring that business process.

Moreover, PTL 2 discloses a technique of searching for business processes having the same purpose, calculating the similarity with the business process between node (task and branch) groups, and displaying the search result according to the similarity. In searching for business processes having the same purpose, a business process is determined to have the “same purpose” based on any one of the following determination conditions; namely, “(1) same business process ID”, “(2) similarity of the business process name”, and “(3) search based on a correspondence table of the business processes having the same purpose defined in advance”.

### CITATION LIST

### Patent Literature

[PTL 1] Japanese Patent Application Publication No. 2012-243268

[PTL 2] Japanese Patent Application Publication No. 2010-176288

### SUMMARY OF INVENTION

### Technical Problem

With the technique of PTL 1, by using the revised business process as the search condition, business processes having a similar task, actor, and task order can be extracted as the influenced business processes. Nevertheless, there is a problem in that PTL 1 is unable to extract the variations in the business processes that have the same business purpose, but have a different task, actor, and task order.

In order to specifically illustrate the foregoing problem, considered is an example of the two business processes of “create notification” and “create medical certificate” in the new contract business of life insurance. The former “create notification” is the business process of a person insured creating a notification describing the health information of such person insured, which will be used as information for screening the underwriting risk of life insurance. Meanwhile, “create medical certificate” is the business process of a physician creating a medical certificate describing the diagnosis information of the person insured, which will be used as information for screening the underwriting risk of life insurance in cases where a huge sum is insured. When comparing the two business processes, while the business purpose of creating information for screening the underwriting risk of life insurance is the same, since the sets of business information; namely, “information of notification” and “information of medical certificate”, used in the respective business processes are different, the task and task order of processing the business information will differ in the two business processes. Needless to say, the actors are also different with one being the person insured and the other being the physician. In this kind of case, even if similar business processes are searched with the technique of PTL 1 by using the business process of “create notification” as the search condition, it will not be possible to extract the business process of “create medical certificate”. Meanwhile, since the business purpose of the two business processes is the same, it is likely that the revision of one will influence the other.

For example, in the business process of “create notification”, let it be assumed that a new business requirement of delivering a copy of the notification to the person insured has been added in order to avoid troubles regarding the duty of notification. In this case, it is likely that the delivery of a copy of the medical certificate will similarly be required in the business process of “create medical certificate”.

With the technique of PTL 2, a business process is determined to have the “same purpose” based on any one of the following determination conditions; namely, “(1) same business process ID”, “(2) similarity of the business process name”, and “(3) search based on a correspondence table of the business processes having the same purpose defined in advance”. Since an influenced business process will differ from the revision source business process, it will have a different business process ID and the business process name may not necessarily be similar. While it will be possible to extract the business process having the same purpose based on determination condition (3), since it is necessary to manually create a correspondence table in advance, much time and labor are required, and there is also the risk of creating an erroneous correspondence table.

Thus, an object of the present invention is to provide a method and a system capable of extracting business variations having the same business purpose by including such business variations in the influenced business processes upon revising a business process.

### Solution to Problem

In order to attain the foregoing object, the present invention extracts business variations by using the logical relation between sets of business information. This is explained in detail below.

Since a business purpose is the creation, referral, update or deletion of business information to be utilized in a certain business operation, when there are business variations having the same business purpose, the tasks utilizing the business information of the respective business variations will be performed alternatively (logical relation of XOR) in the utilization business. Note that, when the series of tasks utilizing the business information of the respective business variations is the same, the business information will be utilized alternatively. For example, in the example shown in FIG. 20, there are the business processes of “create notification” and “create medical certificate” as the business variations, but the respective business purposes are to create “notification information” and “diagnosis information” to be utilized in the subsequent business process of “medical screening”. Moreover, the utilization business of “medical screening” will be the business process in which the task will be performed by alternatively utilizing “notification information” and “diagnosis information” as shown in FIG. 23. Consequently, the business variations having the same business purpose can be extracted based on the XOR relation of the task or business information.

In order to resolve the foregoing problems, the system of the present invention for extracting influenced business processes adopts the following configuration.

A logical relation (AND, OR, XOR) between sets of business information used for a task in the business process is stored in advance. An input device receives a revision of the business process, extracts a difference between pre-revision business process information and post-revision business process information based on the pre-stored business process information, and stores the difference information as revision history information of the business process to be revised. A processing category as a processing type of the business information is analyzed of a pair of task and business information as constituent elements of the post-revision business process, and the information is stored in a storage device. The influenced business processes from the business process information are extracted based on an XOR relation between the sets of business information or an XOR relation of the series of tasks, and an output device displays the influenced business process information. The input device receives a selection of a business process among the influenced business processes, and the output device displays the business process information and the revision history information of the business process to be revised. Note that, while it has been described that the logical relation is stored in advance, the logical relation may also be calculated when it needs to be used.

### Advantageous Effects of Invention

According to the present invention, it is possible to yield an effect of being able to more efficiently extract business processes. The other objects, configurations and effects will become apparent from the ensuing explanation of the embodiments of the present invention.

### BRIEF DESCRIPTION OF DRAWINGS

FIG. 1 is a block diagram of the influenced business process extraction system in one embodiment of the present invention.

FIG. 2 is a block diagram showing a typical hardware configuration of a computer used in the business process information management system in one embodiment of the present invention.

FIG. 3 is a flowchart showing the processing flow of the registration of the business information logical relation, registration of the business process information and influence extraction in one embodiment of the present invention.

FIG. 4 is a flowchart showing the flow of extracting difference information of the business process in one embodiment of the present invention.

FIG. 5 is a flowchart showing the flow of analyzing the processing category of the task and business information in one embodiment of the present invention.

FIG. 6 is a flowchart showing the flow of extracting the influenced business process in one embodiment of the present invention.

FIG. 7 is a table configuration of the task information storage unit in one embodiment of the present invention.

FIG. 8 is a table configuration of the business information information storage unit in one embodiment of the present invention.

FIG. 9 is a table configuration of the business information dictionary storage unit in one embodiment of the present invention.

FIG. 10 is a table configuration of the department/actor list information storage unit in one embodiment of the present invention.

FIG. 11 is a table configuration of the branch information storage unit in one embodiment of the present invention.

FIG. 12 is a table configuration of the connection information storage unit in one embodiment of the present invention.

FIG. 13 is a table configuration of the processing name list information storage unit in one embodiment of the present invention.

FIG. 14 is a table configuration of the revision history information storage unit in one embodiment of the present invention.

FIG. 15 is a table configuration of the business variation information storage unit in one embodiment of the present invention.

FIG. 16 is a business process editing screen example in one embodiment of the present invention.

FIG. 17 is a business information editing screen example in one embodiment of the present invention.

FIG. 18 is an influence extraction result screen example in one embodiment of the present invention.

FIG. 19 is a conceptual diagram of the partial processing of the influenced business process extraction in one embodiment of the present invention.

FIG. 20 is a conceptual diagram of the general process in one embodiment of the present invention.

FIG. 21 is a conceptual diagram of the business process (create notification) in one embodiment of the present invention.

FIG. 22 is a conceptual diagram of the business process (create medical certificate) in one embodiment of the present invention.

FIG. 23 is a conceptual diagram of the business process (medical screening) in one embodiment of the present invention.

### DESCRIPTION OF EMBODIMENTS

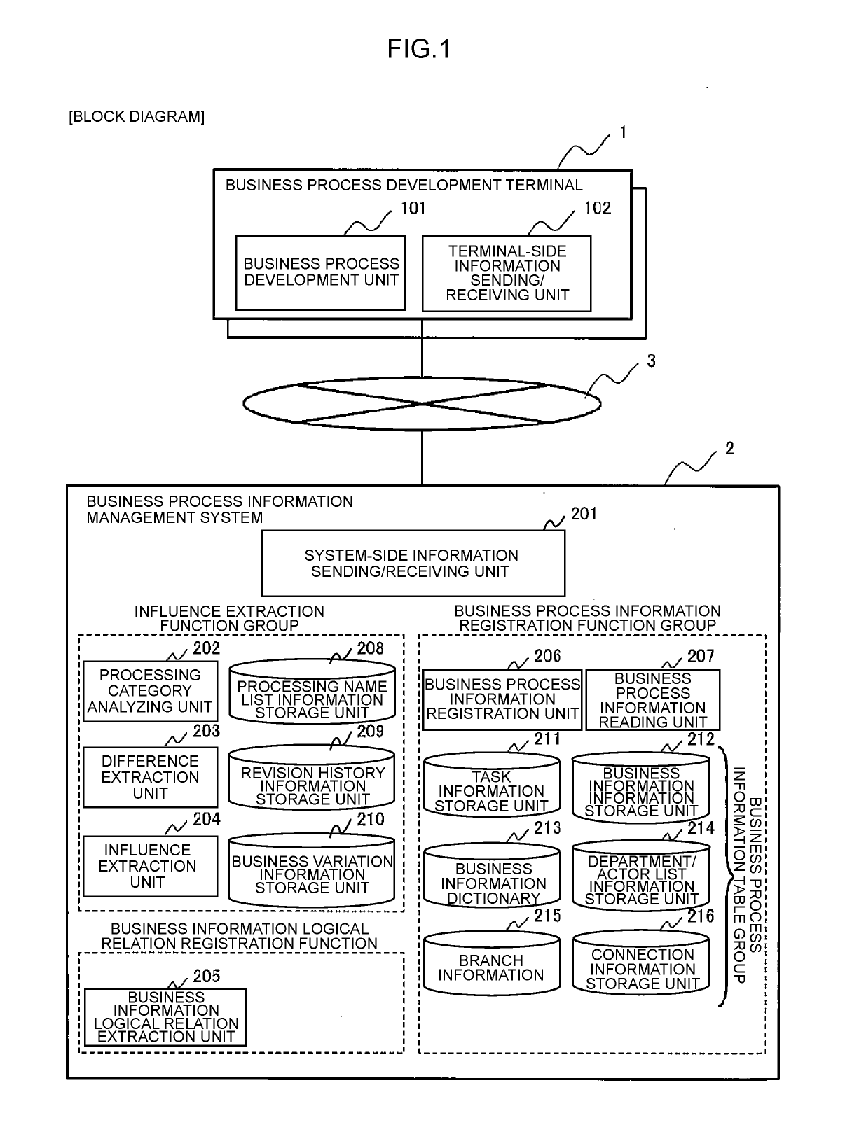

One embodiment of the present invention is now explained. In this embodiment, explained is an influenced business process extraction system capable of extracting business variations having the same business purpose by including such business variations in the influenced business processes upon revising a business process. FIG. 1 shows the influenced business process extraction system. As shown in FIG. 1, the influenced business process extraction system is configured from a business process development terminal 1 comprising a business process development unit 101 and a terminal-side information sending/receiving unit 102 which sends and receives business process information, and a business process information management system 2 which receives an input of a logical relation of business information, registers the edited business process, and extracts the influenced business processes.

In this embodiment, while examples of business processes related to insurance are described as the category of business, the present invention is not limited thereto, and may also be applied to cases of designing business processes in enterprise information system development irrespective of the category of business.

A business process is foremost explained. There are numerous notation methods of a business process, and, for instance, there is BPMN (Business Process Model and Notation) formulated by the international standards body OMG. In this embodiment, while the explanation will be provided by adopting BPMN as the notation method, the present invention may be applied without limitation to BPMN so as long as business information, I/O relation of business information, and logical relation between sets of business information are included in the business process information.

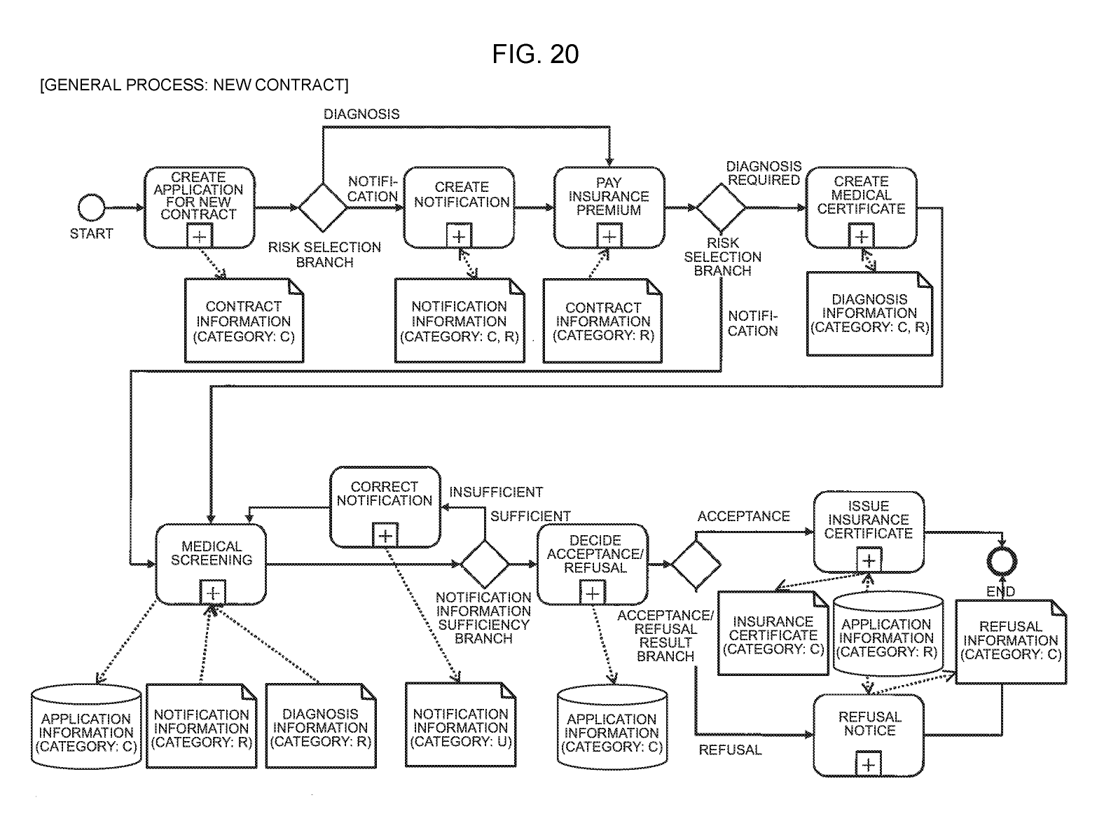

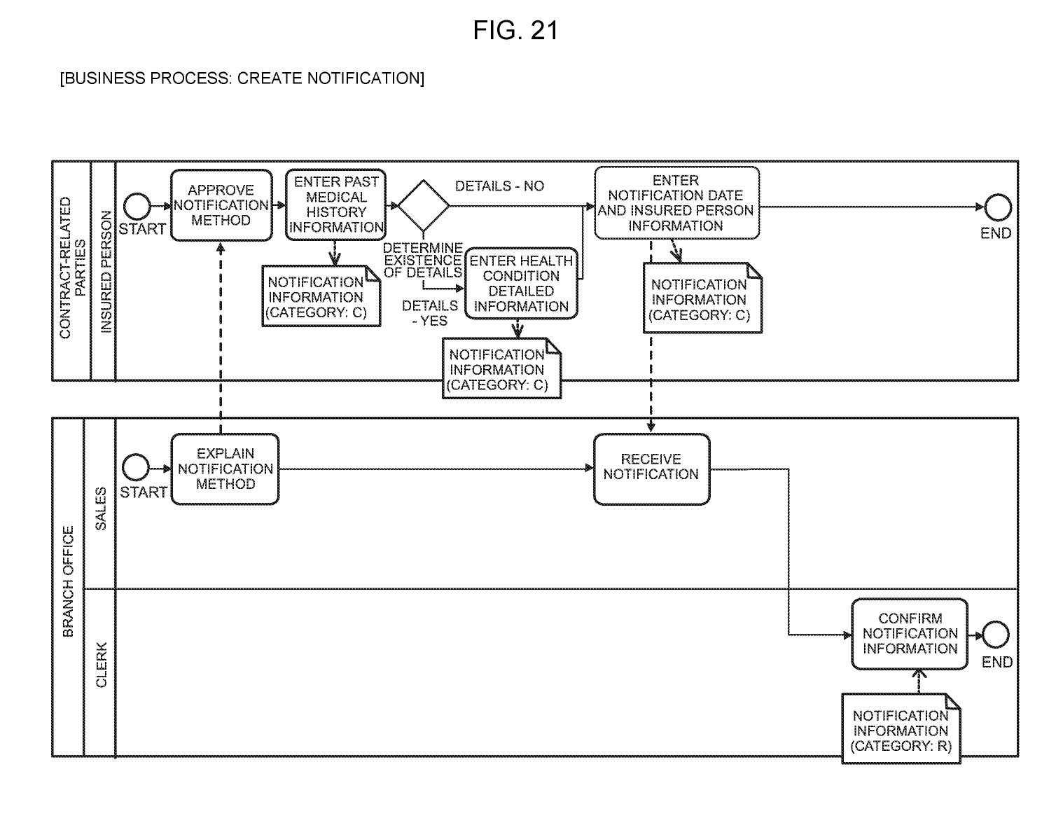

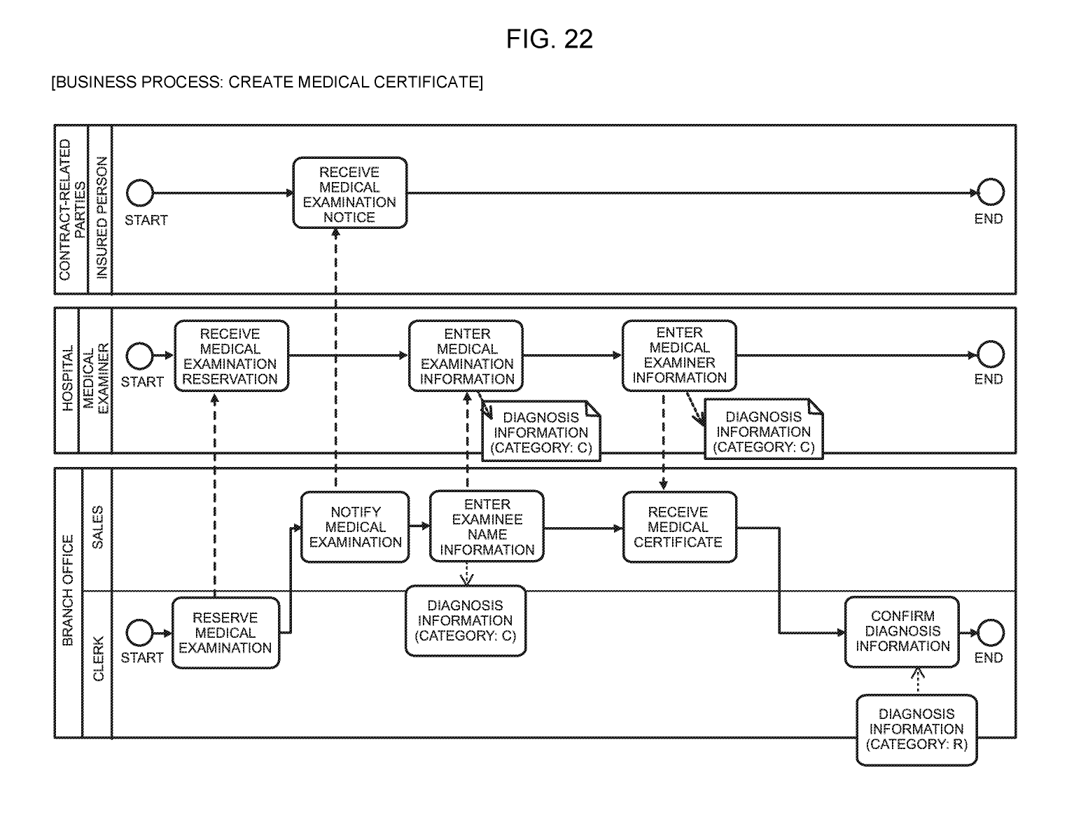

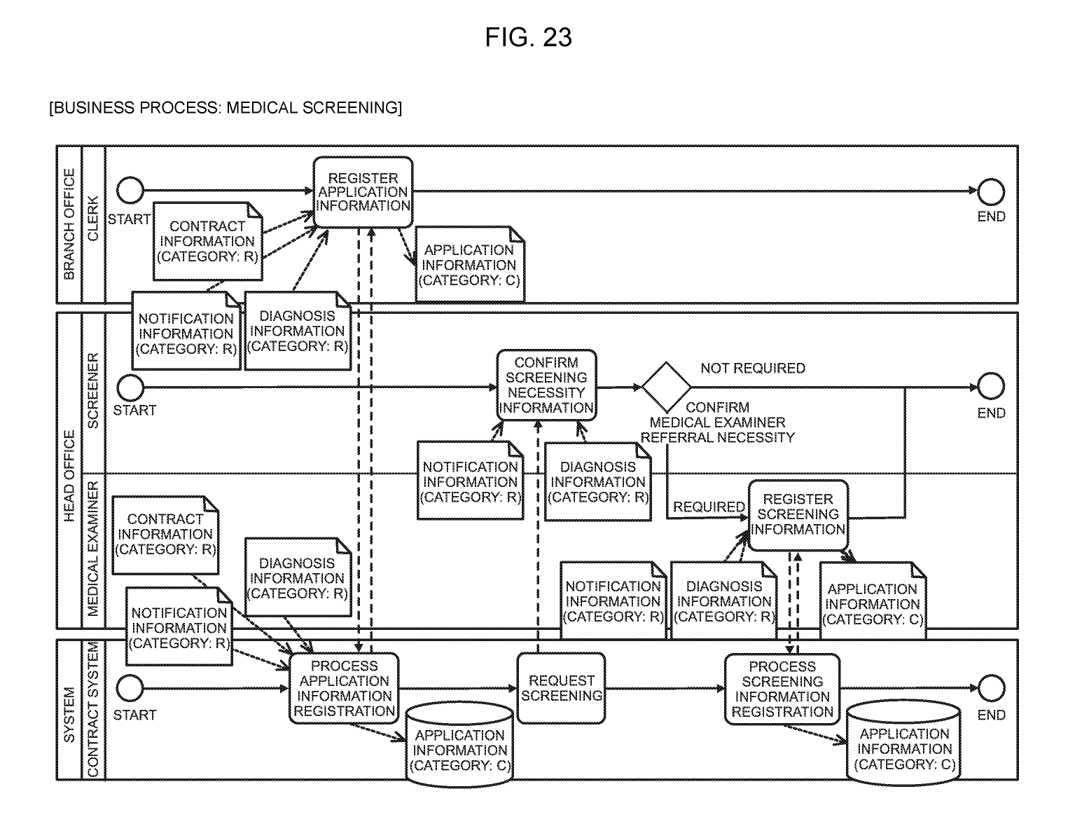

A business process is now explained in detail with reference to FIG. 20 to FIG. 23. FIG. 20 is a diagram which expresses the general process of a new contract business based on BPMN. The constituent elements of the general process include a business process, business information, I/O relation of business information, branch and branch condition, sequence flow, start event, and end event. Moreover, the business process may also adopt a hierarchy structure. For example, details of “create notification” in FIG. 20 are expressed as the business process of FIG. 21. In the business process of “create notification” in FIG. 21, task, pool, and lane are described in addition to the constituent elements of the general process. FIG. 22 and FIG. 23 are each a detailed diagram of “create medical certificate” and “medical screening” in FIG. 20, and have the same constituent elements as “create notification”. Note that the shapes and meanings of the symbols used in the diagrams are in compliance with BPMN, and the explanation thereof is omitted since they are not the features of the present invention. Moreover, while a processing category (for instance, Category: C, etc.) is described in the business information, this is automatically determined in processing S204 described later. The influenced business process extraction system that is operated based on the foregoing background is now explained in detail.

===Overview of Embodiment===

In this embodiment, foremost, the business process development terminal 1 makes an inquiry to the business process information management system 2 regarding a business process in which the logical relation of business information is undefined, and the business process information management system 2 extracts the business process which coincides with the inquired condition and sends the extracted business process to the business process development terminal 1, the business process development terminal 1 receives an input of the logical relation of the business information that is undefined and sends the input logical relation of the business information to the business process information management system 2, the business process information management system 2 registers the logical relation of the business information, the business process development terminal 1 subsequently receives a revision input of the business process from the business process developer, the business process information management system 2 registers the revised business process, the business process information management system 2 extracts the influenced business processes according to the influence extraction instruction received by the business process development terminal 1, and the business process development terminal 1 displays the influenced business processes to the business process developer.

In this system, the business process development terminal 1 and the business process information management system 2 are connected via a communication network 3. Note that a plurality of business process development terminals 1 may also be connected to the communication network 3. Moreover, the business process development terminal 1 and the business process information management system 2 may also be installed within a single computer system without going through a communication network. Furthermore, the business process information registration function group within the business process information management system 2 may also be installed in a separate computer system. In this embodiment, explained is a case where the business process development terminal 1 and the business process information management system 2 are each installed in a different computer system, and operated by being installed at remote locations. The communication network 3 is a LAN, internet, or any other arbitrary wired or wireless network. The business process development terminal 1 and the business process information management system 2 are each a computer comprising a CPU for performing arithmetic processing, a storage device (for example, RAM, ROM, hard disk, etc.) for storing data and programs, and a communication device for communicating with external equipment via the network 3.

===Hardware Configuration===

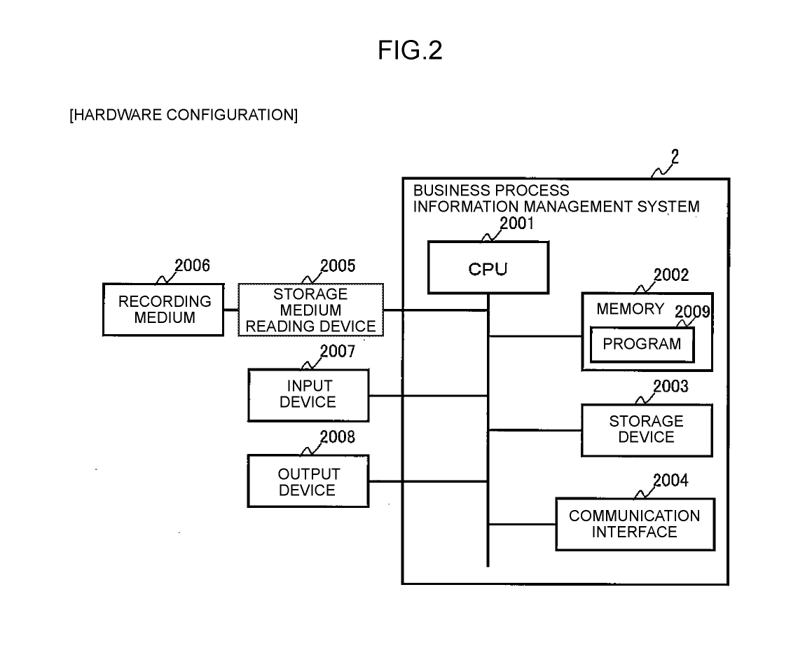

FIG. 2 shows the typical hardware configuration of a computer used as the business process information management system 2. The computer configured as shown in FIG. 2 is also used as the business process development terminal 1. As shown in FIG. 2, the business process information management system 2 comprises a CPU 2001, a memory 2002, a storage device 2003, a communication interface 2004, a recording medium reading device 2005, a recording medium 2006, an input device 2007, and an output device 2008.

The CPU 2001 realizes various functions by executing programs 2009 of the business process information management system 2 stored in the memory 2002. The recording medium reading device 2005 is a device for reading the programs and data recorded in the recording medium 2006. The read programs and data are stored in the memory 2002. Accordingly, for instance, the programs 2009 stored in the memory 2002 may be read from the recording medium 2006 by using the recording medium reading device 2005, and then stored in the memory 2002. As the recording medium 2006, used may be, for example, a CD-ROM, a DVD-ROM, a hard disk, a flexible disk, a semiconductor memory, a magnetic tape or the like. The recording medium reading device 2005 may be built into the business process information management system 2, or may be provided outside the business process information management system 2. The input device 2007 is used by an operator to input data and the like into the business process information management system 2. As the input device 2007, used may be, for example, a keyboard, a mouse, a microphone or the like. The output device 2008 is a device for externally outputting information. As the output device 2008, used may be, for example, a display, a printer, a speaker or the like. The communication interface 2004 is a device for connecting to the communication network 3 to enable communication with the business process development terminal 1

A processing name list information storage unit 208, a revision history information storage unit 209, a business variation information storage unit 210, a task information storage unit 211, a business information information storage unit 212, a business information dictionary 213, a department/actor list information storage unit 214, a branch information storage unit 215 and a connection information storage unit 216 shown in FIG. 1 are provided in the storage device 2003. Moreover, a system-side information sending/receiving unit 201, a processing category analyzing unit 202, a difference extraction unit 203, an influence extraction unit 204, a business information logical relation extraction unit 205, a business process information registration unit 206 and a business process information reading unit 207 are stored in the memory 2002, and realized as programs that are executed by the CPU 2001. Moreover, data is input to the respective computers via the input device 2007.

===Work Process Development Terminal 1===

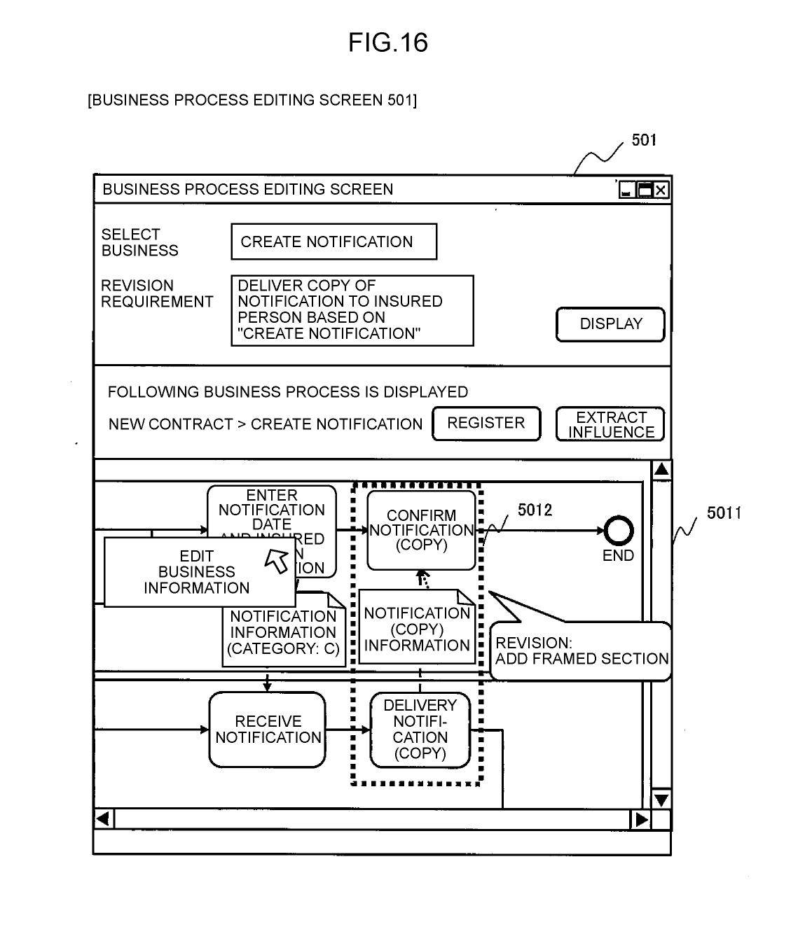

In the business process development terminal 1 of FIG. 1, the business process development unit 101 comprises a business process development function and comprises, as shown in FIG. 16 to FIG. 18, the functions of displaying a screen for editing the business process, displaying a screen for editing the business information, displaying a screen of the influence extraction result, and displaying a screen showing the reception of the influenced business process selected by the business process developer and the revision history of the revision source business process.

The terminal-side information sending/receiving unit 102 comprises a function of sending newly developed or revised business process information (including business information information) to the system-side information sending/receiving unit 201 of the business process information management system 2, and receiving, from the system-side information sending/receiving unit 201 of the business process information management system 2, business process information in which the logical relation of business information is undefined, influenced business process information, and revision history information of the revision source business process.

===Work Process Information Management System 2===

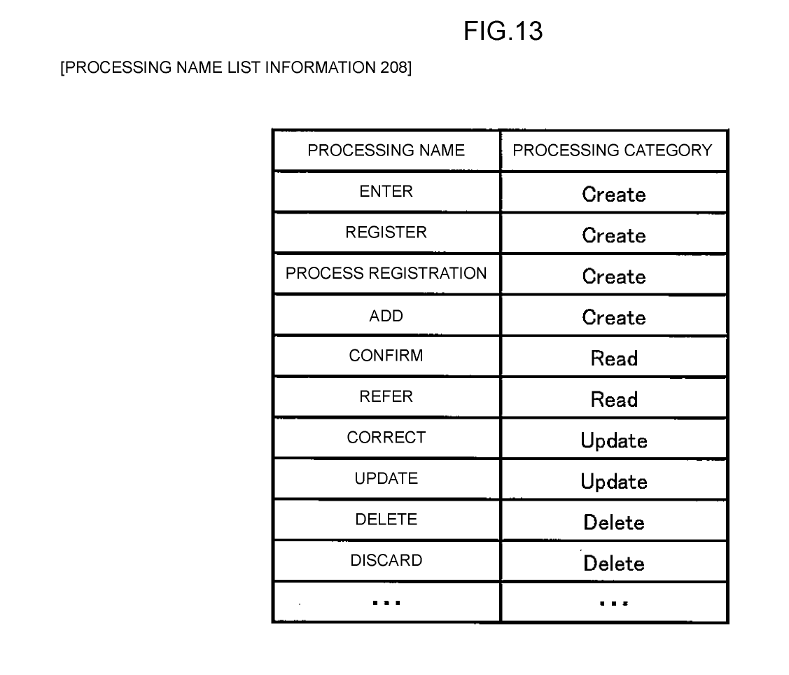

In the business process information management system 2 of FIG. 1, the processing name list information storage unit 208 stores, as shown in FIG. 13, the processing name of the task and the processing category corresponding to the processing name as the constituent elements of the business process. Here, the processing category shows the relation between the business process and the task and business information, and will be one among “Create”, “Read”, “Update”, and “Delete” according to the forms or processing performed to the business system (file, DB) based on the business process and the task. “Create” means creating or adding new business information, “Read” means reading existing business information, “Update” means updating existing business information, and “Delete” means deleting existing business information. The processing name list information is used for commonalizing the processing name of tasks and for the processing category analysis of processing S204 described later. As the task of processing business information, a name configured from “business information”+“processing name” may be assigned, and the business process developer is caused to select the processing name from the processing list information in the course of defining the tasks for commonalizing the “processing name”. In this embodiment, the processing name list information is retained in advance, but the processing name and the processing category may be edited as needed.

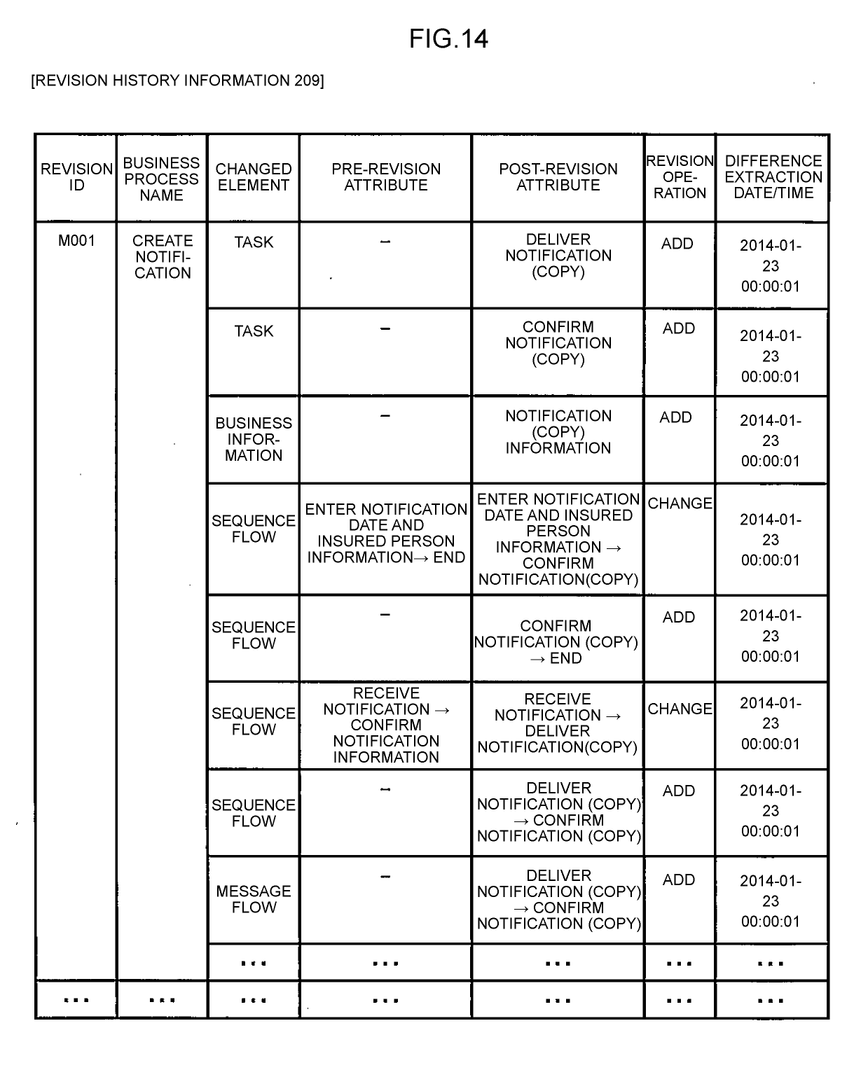

The revision history information storage unit 209 stores, as shown in FIG. 14, a revision ID, a business process name, a changed element, a pre-revision attribute, a post-revision attribute, a revision operation, and a difference extraction date/time. Here, revision operation is one among addition, change, and deletion performed to the constituent element of the business process.

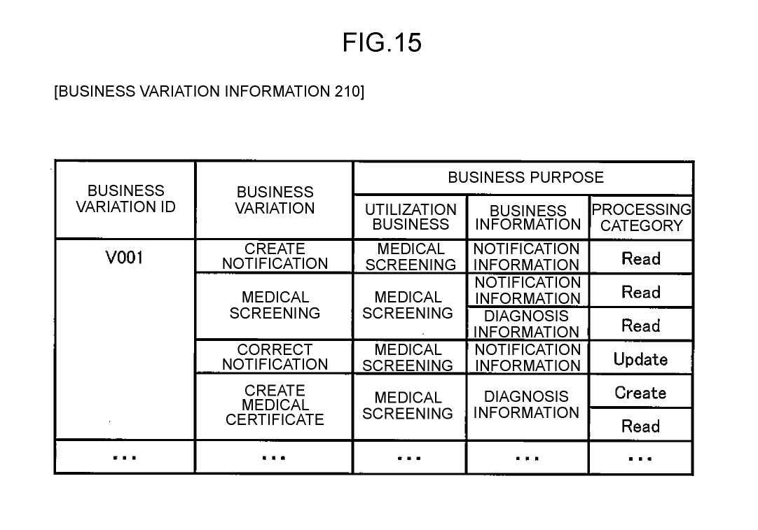

The business variation information storage unit 210 stores, as shown in FIG. 15, a business variation ID, a business variation, and a business purpose. Here, business purpose is one among creation, reference, update, and deletion of business information to be utilized in a certain business operation. For example, the business purpose of the business variation of “create notification” having a business variation ID of “V001” is to “Read” (refer to), as the processing category, the business information of “notification information” to be utilized in the utilization business of “medical screening”.

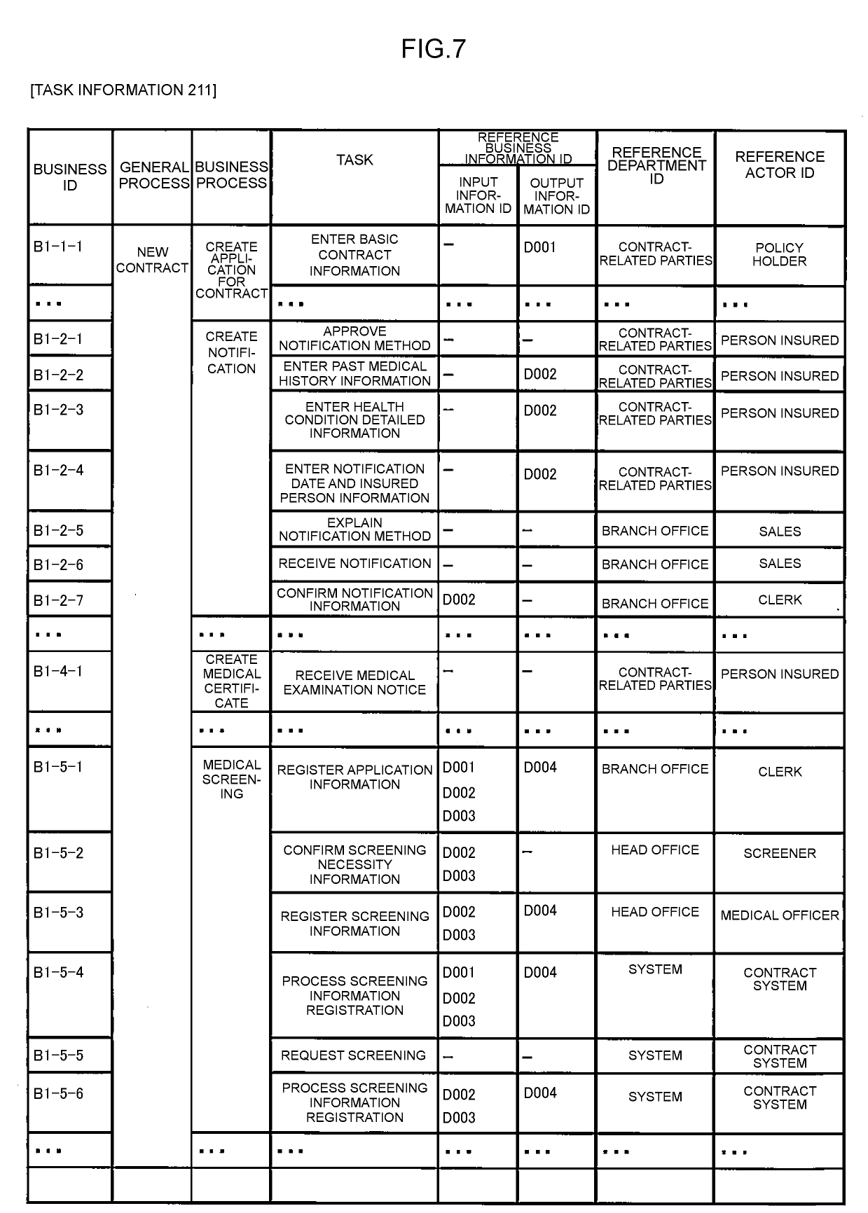

The task information storage unit 211 stores, as shown in FIG. 7, a business ID, a general process, a business process, a task, a reference business information ID, a reference department ID, and a reference actor ID.

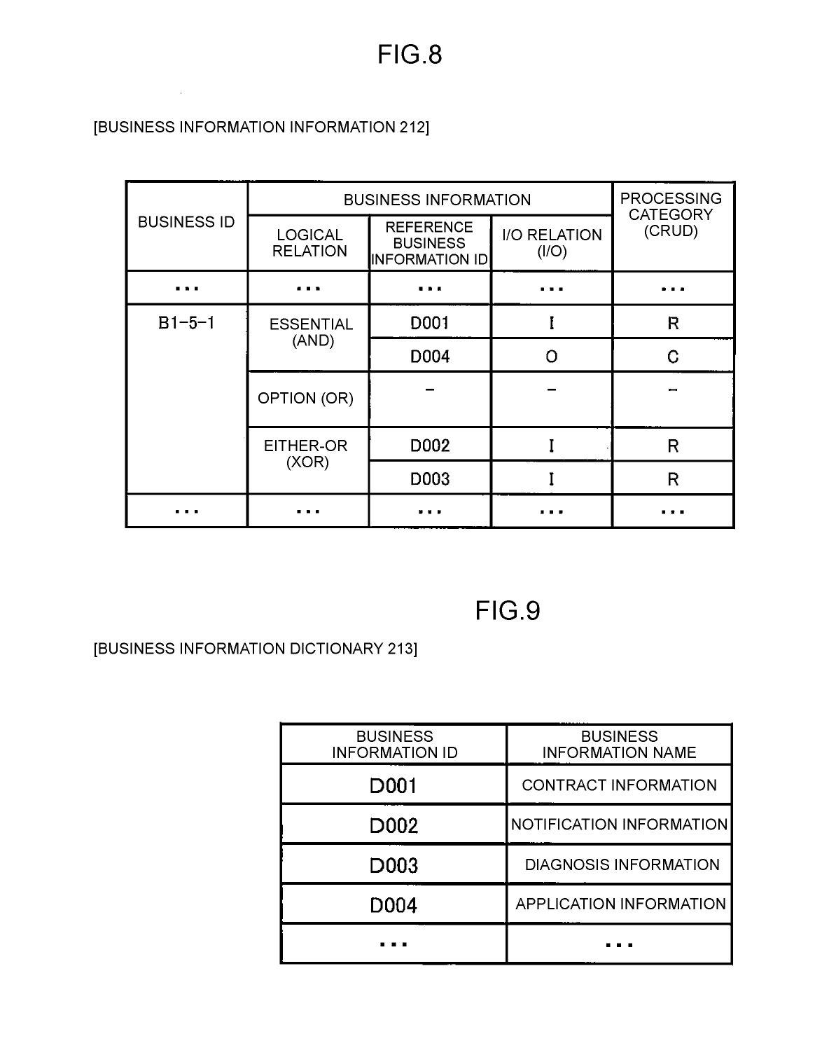

The business information information storage unit 212 stores, as shown in FIG. 8, a business ID, business information, and a processing category (CRUD). Note that the business information is configured from a logical relation (AND, OR, XOR) between sets of business information, a reference business information ID, and an I/O relation (I/O).

The business information dictionary 213 is the dictionary information of business information and stores, as shown in FIG. 9, a business information ID, and business information name. The business information dictionary 213 is used for commonalizing the business information in the business process. For example, the diffusion of business information is prevented by selecting the business information among the business information names stored in the business information dictionary upon defining the business information. Moreover, in this embodiment, while the business information dictionary is retained in advance, the business information ID and the business information name may be edited as needed.

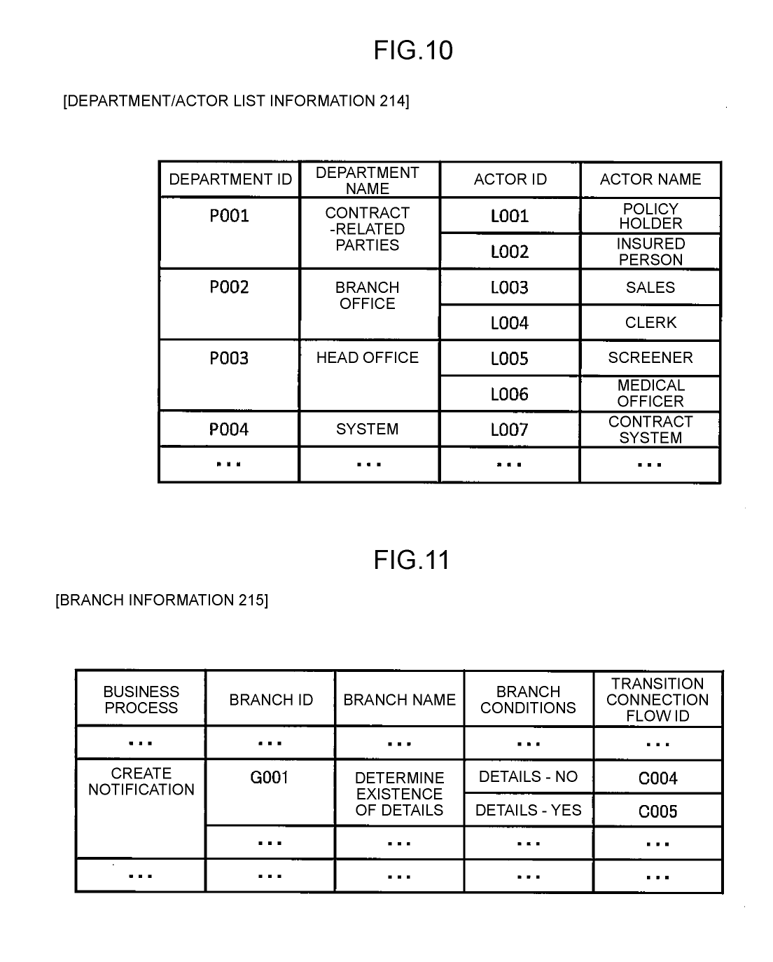

The department/actor list information storage unit 214 stores, as shown in FIG. 10, a department ID, a department name, an actor ID, and an actor name. The department/actor list information storage unit 214 is also used for commonalizing the department name and the actor name in the same manner as the business information dictionary 213, and can be edited as needed.

The branch information storage unit 215 stores, as shown in FIG. 11, a business process, a branch ID, a branch name, a branch condition, and a transition connection flow ID.

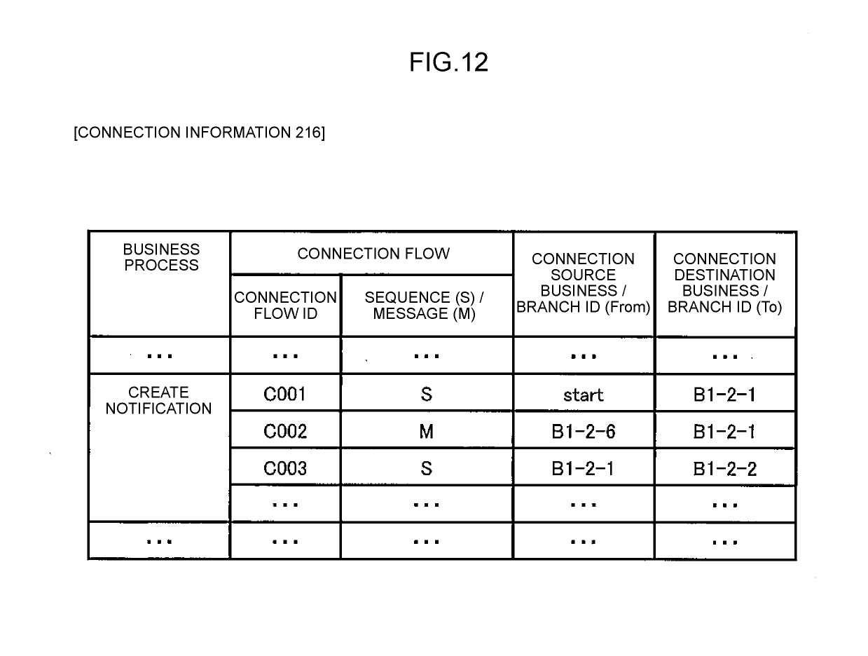

The connection information storage unit 216 stores, as shown in FIG. 12, a business process, a connection flow (connection flow ID, sequence (S))/message (M)), a connection source business/branch ID (From), and a connection destination business/branch ID (To).

Note that the data stored in the task information storage unit 211, the business information information storage unit 212, the business information dictionary 213, the department/actor list information storage unit 214, the branch information storage unit 215 and the connection information storage unit 216 is data of the table structure configuring the business process, but it may also be retained as data of a tree structure as represented by XML.

The system-side information sending/receiving unit 201 comprises a function of receiving, from the business process development terminal 1, an inquiry regarding the business process information in which the logical relation of business information is undefined, information concerning the logical relation of business information, revised business process information, influence extraction instruction information of the business process, and selection information of the business process selected by the business process developer, and sending, to the business process development terminal 1, business process information in which the logical relation of business information is undefined, influence extraction result information, and revision history information of the revision source business process.

The processing category analyzing unit 202 comprises a function of analyzing the processing category from the I/O relation and the processing name list information storage unit 208 based on the combination of the task and business information as the constituent elements of the business process sent from the business process development terminal 1.

The difference extraction unit 203 comprises a function of extracting the difference between the pre-revision business process and the post-revision business process of the business process information sent from the business process development terminal 1.

The influence extraction unit 204 comprises a function of extracting the influenced business processes based on the business information to be used in the business process to be revised.

The business information logical relation extraction unit 205 comprises a function of extracting the task and business information in which the logical relation between the sets of business information is undefined in the business process for which an inquiry was received from the business process development terminal 1.

The business process information registration unit 206 comprises a function of storing the business process information sent from the business process development terminal 1, processing category of the business information and information concerning the logical relation in the task information storage unit 211, the business information information storage unit 212, the branch information storage unit 215 and the connection information storage unit 216, and storing the revision history information in the revision history information storage unit 209.

The business process information reading unit 207 comprises a function of reading the required business process information from the task information storage unit 211, the business information information storage unit 212, the branch information storage unit 215 and the connection information storage unit 216 in response to inquiries concerning various types of business process information.

===Overview of System Processing===

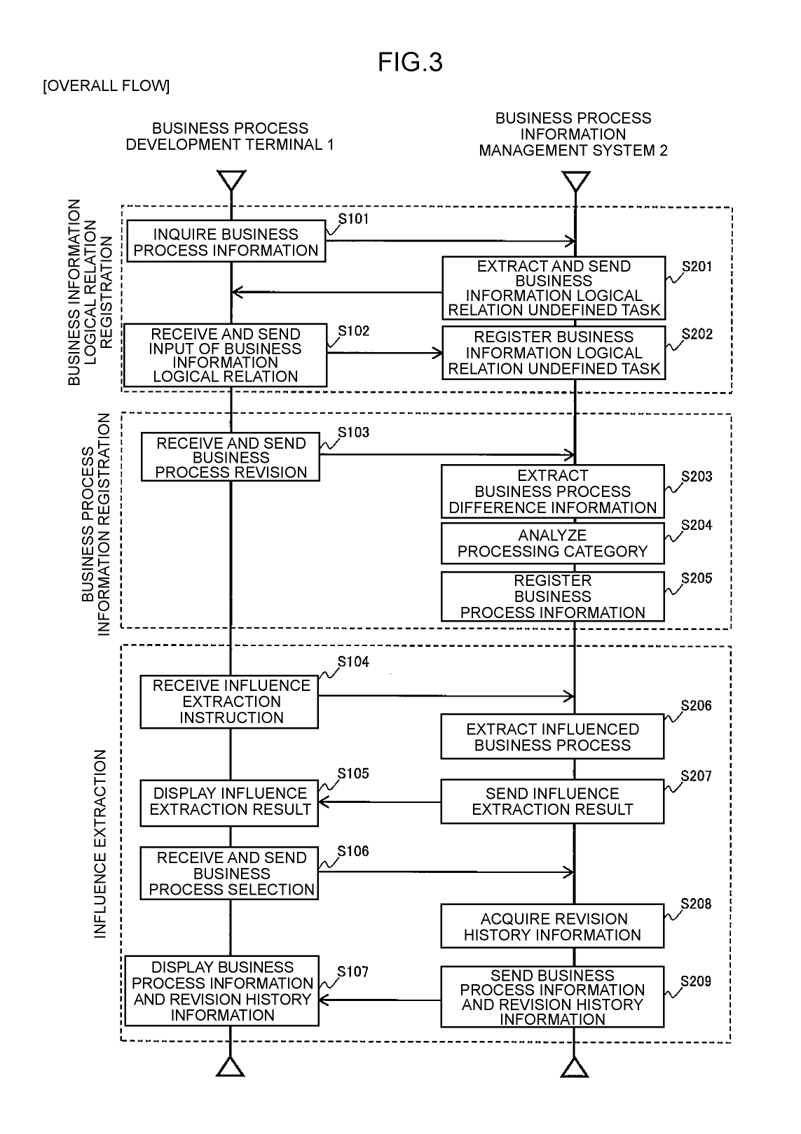

FIG. 3 is a flowchart showing the processing flow of the registration of the business information logical relation, registration of the business process information and influence extraction in the influenced business process extraction system. Moreover, the processing shown in FIG. 3 is realized by the CPU executing programs in the business process development terminal 1 and the business process information management system 2, respectively.

Processing S101 to processing S107 are processes that are executed by the business process development terminal 1, and processing S201 to processing S209 are processes that are executed by the business process information management system 2, respectively.

===Processing of Business Information Logical Relation Registration===

The business process information of a standard specification such as BPMN does not include the logical relation of business information which is required in the influence extraction processing described later. In this processing, a business process in which the logical relation of business information is undefined is extracted, and information of the logical relation of business information that was input by the business process developer for the business process is registered.

<Processing S101>

Processing S101 is now explained with reference to FIG. 3. The terminal-side information sending/receiving unit 102 of the business process development terminal 1 receives an inquiry instruction from the business process developer regarding a business process in which the logical relation of business information is undefined, and sends the inquiry of the corresponding business process to the business process information management system 2.

<Processing S201>

The business information logical relation extraction unit 205 of the business process information management system 2 scans the “logical relation” and the “reference business information ID” of the business information information storage unit 212, extracts the business ID in which the logical relation of business information is undefined, and sends the business process including the task of the corresponding business ID to the terminal-side information sending/receiving unit 102 of the business process development terminal 1.

<Processing S102>

The information sending/receiving unit 101 of the business process development terminal 1 receives the business process information in which the logical relation of business information is undefined from the business process information management system 2, the business process development unit 101 receives an input of the logical relation of business information from the business process developer, and the terminal-side information sending/receiving unit 102 sends the information concerning the logical relation of business information to the system-side information sending/receiving unit 201 of the business process information management system 2.

<Processing S202>

The business process information registration unit 206 of the business process information management system 2 registers, in the business information information storage unit 212, the information concerning the logical relation of business information sent from the business process development terminal 1.

===Processing of Business Process Information Registration===

The processing of receiving business process information that was revised by the business process developer, extracting the difference before and after the revision, analyzing the processing category of business information, and registering the business process information, difference information and processing category information is now explained. Here, the difference information is intended for suggesting the contents of revision when the business process developer revises the influenced business processes and supporting the revision of the business process, and the processing category information is information that is required in the influence extraction processing.

<Processing S103>

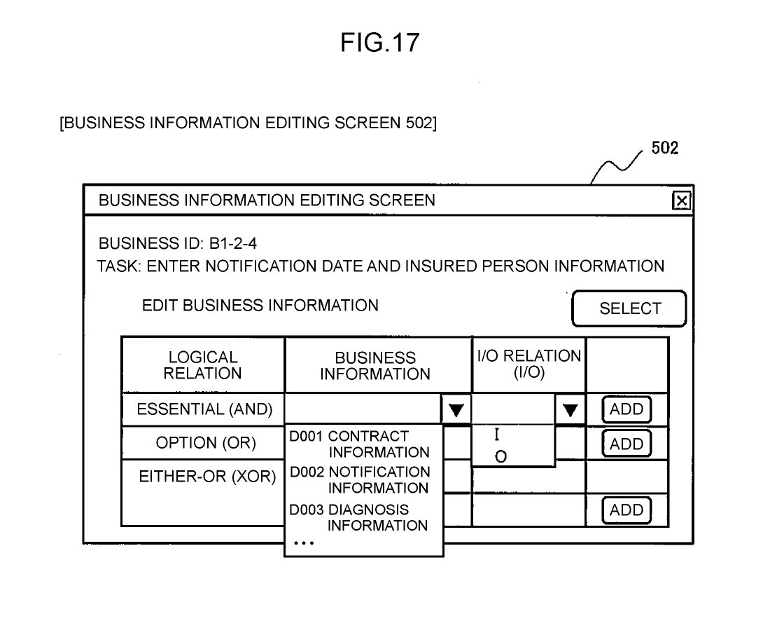

The business process development unit 101 of the business process development terminal 1 receives the revision of the business process pursuant to changes in the business requirement made by the business process developer, and the terminal-side information sending/receiving unit 102 sends the revised business process information to the business process information management system 2. In this embodiment, for example, on the business process editing screen 501 shown in FIG. 16, the additional input of a framed section 5012 including the task of “confirm notification (copy)” and other tasks is received in the business process editing area 5011 of the displayed business process of “create notification” according to the revision requirement of “deliver copy of notification to insured person based on ‘create notification’”, and the revised business process information is sent to the business process information management system 2. The timing of sending information shall be, for instance, when the “Register” button of FIG. 16 is pressed. Note that, when the business information is to be revised, for instance, by selecting the task in which the business information is to be edited, displaying a right-click menu, and selecting “edit business information”, the business information editing screen 502 shown in FIG. 17 is activated, the required editing of business information is received, the screen is closed by the “Select” button being pressed, and the screen thereafter returns to the business process editing screen 501.

<Processing S203>

Returning to the explanation of FIG. 3, the difference extraction unit 203 of the business process information management system 2 receives the business process information sent from the terminal-side information sending/receiving unit 102 of the business process development terminal 1, and executes the processing for extracting the difference between the pre-revision business process and the and post-revision business process.

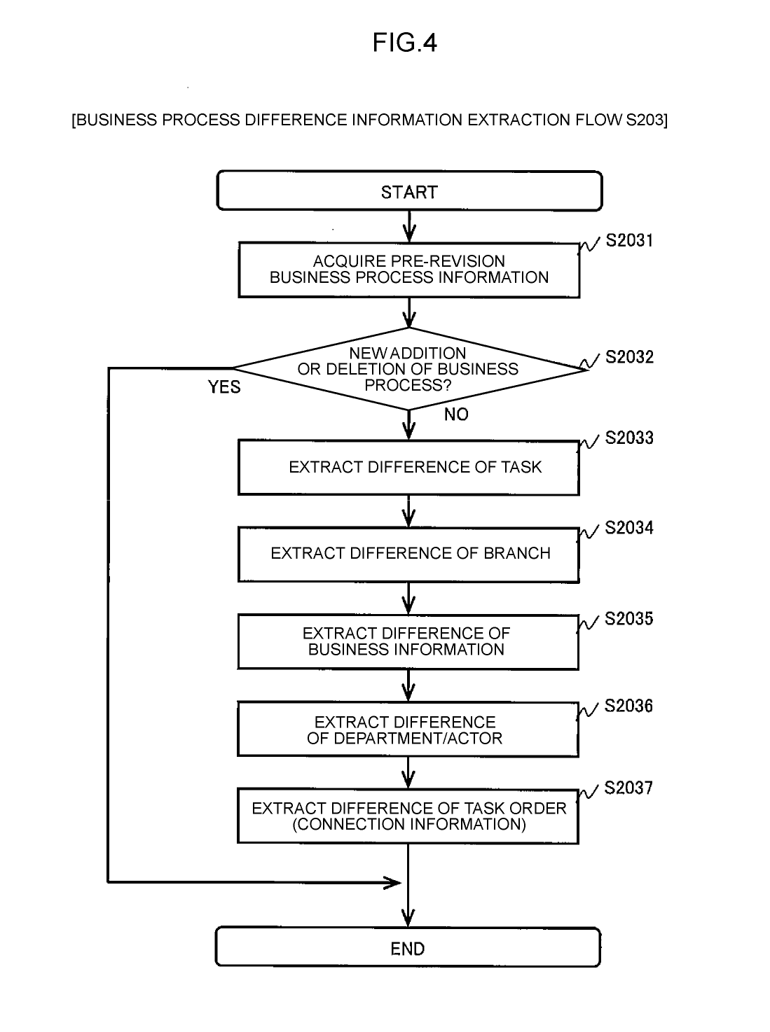

Details of processing S203 will be the processes of processing S2031 to processing S2037 in the flowchart shown in FIG. 4. FIG. 4 is a flowchart showing the processing flow of extracting difference information of the business process in the business process information management system 2.

<Processing S2031>

The business process information reading unit 207 of the business process information management system 2 reads pre-revision business process information from the task information storage unit 211, the business information information storage unit 212, the branch information storage unit 215, and the connection information storage unit 216. In this embodiment, the business process information reading unit 207 reads the task information of business ID “B1-2-1” to business ID “B1-2-7” from the task information storage unit 211, reads business information information of business ID “B1-2-1” to business ID “B1-2-7” from the business information information storage unit 212, reads branch information included in the business process of “create notification” from the branch information storage unit 215, and reads connection information included in the business process of “create notification” from the connection information storage unit 216.

<Processing S2032>

When the revision of the business process is a new addition or deletion of a business process, processing S203 is ended. Meanwhile, when the revision of the business process is not a new addition or deletion of a business process; that is, when it is a change in the business process, processing S2033 is executed. This is because, when the revision is a new addition or deletion of a business process, the business process information will become the difference information even without extracting the difference. The processing can thereby be optimized by minimizing the execution of subsequent processing only when necessary.

<Processing S2033>

The difference extraction unit 203 of the business process information management system 2 compares the task information of the pre-revision business process and the post-revision business process, and extracts the task name as the pre-revision attribute and the post-revision attribute, and “Add”, “Change” or “Delete” as the revision operation. In this embodiment, “-” is extracted as the pre-revision attribute which means “not applicable, “confirm notification (copy)” is extracted as the post-revision attribute, and “Add” or the like is extracted as the revision operation.

<Processing S2034>

The difference extraction unit 203 of the business process information management system 2 compares the branch information of the pre-revision business process and the post-revision business process, extracts the branch name as the pre-revision attribute and the post-revision attribute, and extracts “Add”, “Change” or “Delete” as the revision operation. In this embodiment, the branch information is not revised.

<Processing S2035>

The difference extraction unit 203 of the business process information management system 2 compares the business information information of the pre-revision business process and the post-revision business process, and extracts the business information name as the pre-revision attribute and the post-revision attribute, and extracts “Add”, “Change” or “Delete” as the revision operation. In this embodiment, “-” is extracted as the pre-revision attribute, “notification (copy) information” is extracted as the post-revision attribute, and “Add” is extracted as the revision operation.

<Processing S2036>

The difference extraction unit 203 of the business process information management system 2 compares the reference department ID and the reference actor ID of the task information of the pre-revision business process and the post-revision business process, extracts the department and actor name as the pre-revision attribute and the post-revision attribute, and extracts “Add”, “Change” or “Delete” as the revision operation. In this embodiment, information concerning the department and actor is not revised.

<Processing S2037>

The difference extraction unit 203 of the business process information management system 2 compares the connection information of the pre-revision business process and the post-revision business process, extracts the connection source business/branch name and connection destination business/branch name of the pre-revision attribute and the post-revision attribute, respectively, and extracts “Add”, “Change” or “Delete” as the revision operation. In this embodiment, “enter notification date and insured person information->end” is extracted as the pre-revision attribute, “enter notification date and insured person information->confirm notification (copy)” is extracted as the post-revision attribute, and “Change” or the like is extracted as the revision operation.

<Processing S204>

Returning to the explanation of FIG. 3, the processing category analyzing unit 202 of the business process information management system 2 implements processing for determining the processing category from the I/O relation and the processing name list information storage unit 208 based on the combination of the task and business information as the constituent elements of the edited business process.

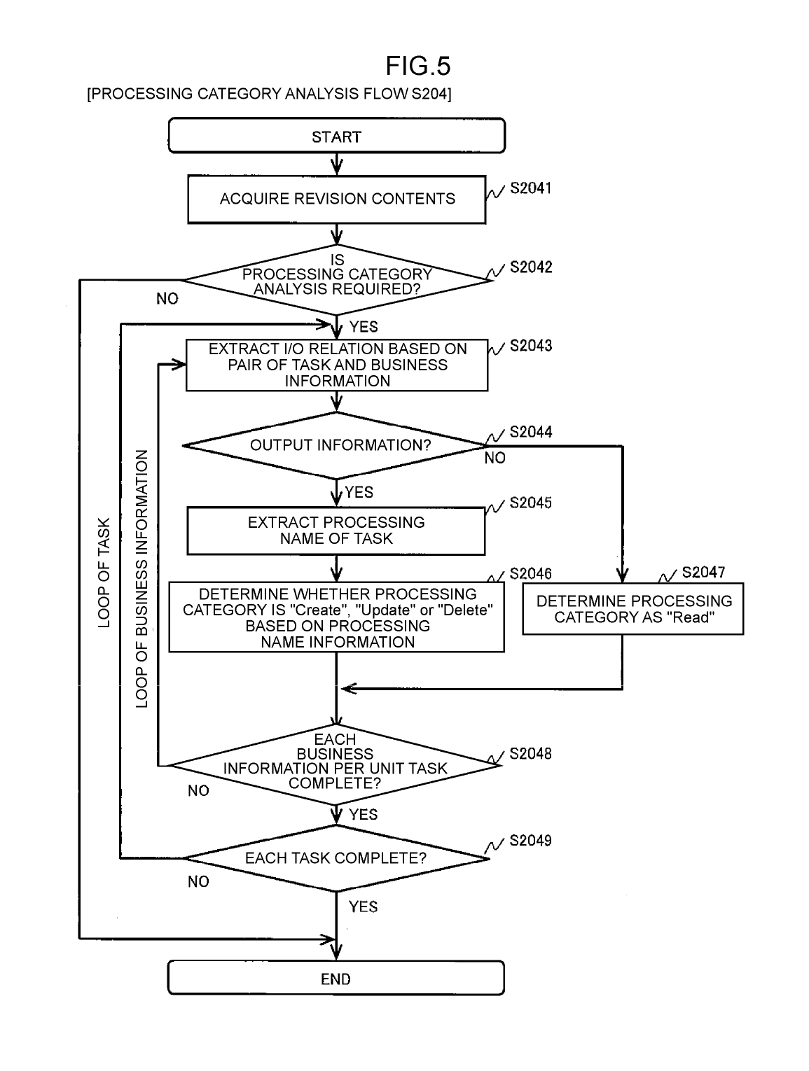

Details of processing S204 will be the processes of processing S2041 to processing S2049 in the flowchart shown in FIG. 5. FIG. 5 is a flowchart showing the processing flow of analyzing the processing category in the business process information management system 2.

<Processing S2041>

The processing category analyzing unit 202 of the business process information management system 2 acquires the business process information to be revised. In this embodiment, the information of the business process of “create notification” is acquired.

<Processing S2042>

The processing category analyzing unit 202 of the business process information management system 2 executes processing S2043 when processing category analysis is required according to the revision, and ends processing S204 when processing category analysis is not required. Here, revisions that require the processing category analysis are the addition of a business process, addition of a task or business information, and change to the I/O relation of the business information or the processing name. Meanwhile, revisions that do not require the processing category analysis are all other cases; that is, deletion of a task or I/O information, or deletion of a business process. Based on the foregoing processing, it is possible to optimize processing S204 by executing the processing category analysis only when the processing category is added or changed. In this embodiment, since the task and business information are added in the business process of “create notification” to be revised, this corresponds to a revision which requires the analysis of the processing category.

<Processing S2043>

The processing category analyzing unit 202 of the business process information management system 2 extracts the I/O relation of the pair of task and business information. In this embodiment, for example, the I/O relation of the pair of the task of “enter past medical history information” and the business information of “notification information” is “output”, and the I/O relation of the task of “confirm notification information” and the business information of “notification information” is “input”.

<Processing S2044>

When the I/O relation of the pair of task and business information is an output relation, processing S2045 is executed, and the I/O relation is an input relation, processing S2047 is executed.

<Processing S2045>

The processing category analyzing unit 202 of the business process information management system 2 extracts the processing name of the task. In this embodiment, for example, “Enter” is extracted as the processing name of the task of “enter past medical history information”.

<Processing S2046>

The processing category analyzing unit 202 of the business process information management system 2 compares the extracted processing name of the task and the processing name list information of the processing name list information storage unit 208, and determines whether the processing category is “Create”, “Update”, or “Delete”. In this embodiment, for example, the processing category of “Create” corresponding to the extracted processing name of “Enter” of the task of “enter past medical history information” is read, and the processing category is thereby determined as “Create”.

<Processing S2047>

The processing category analyzing unit 202 of the business process information management system 2 determines the processing category as “Read” when the I/O relation of the pair of task and business information is an input relation since this will be the processing of reading existing information. In this embodiment, since the I/O relation of the pair of the task of “confirm notification information” and the business information of “notification information” is an input relation, the processing category is determined as “Read”.

<Processing S2048>

When the processing category analysis of each piece of business information linked to the task is complete, processing S2049 is executed, and when the processing category analysis is not yet complete, processing S2043 is executed.

<Processing S2049>

When the processing category analysis of each task in the business process is complete, processing S204 is ended, and when the processing category analysis is not yet complete, processing S2043 is executed.

<Processing S205>

Returning to the explanation of FIG. 3, the business process information registration unit 206 of the business process information management system 2 stores the revised business process information in the task information storage unit 211, the business information information storage unit 212, the branch information storage unit 215, and the connection information storage unit 216, stores the difference information extracted in processing S203 in the revision history information storage 209, and stores the processing category determined in processing S204 in the processing category (CRUD) of the business information information storage unit 212.

===Processing of Influence Extraction===

The processing of extracting influenced business process information based on the business process information to be revised, and displaying the business process information which was selected and received among the influenced business processes, together with the revision history information of the business process to be revised, to the business process developer is now explained.

<Processing S104>

The business process development unit 101 of the business process development terminal 1 receives an influence extraction instruction from the business process developer, and the terminal-side information sending/receiving unit 102 sends the revised business process information and the influenced business process extraction instruction information to the business process information management system 2. The timing of sending information shall be, for example, when the “influence extraction” button of FIG. 16 is pressed.

<Processing S206>

Returning to the explanation of FIG. 3, the influence extraction unit 204 of the business process information management system 2 receives the revised business process information and the influence extraction instruction instruction information sent from the terminal-side information sending/receiving unit 102 of the business process development terminal 1, and extracts the influenced business processes.

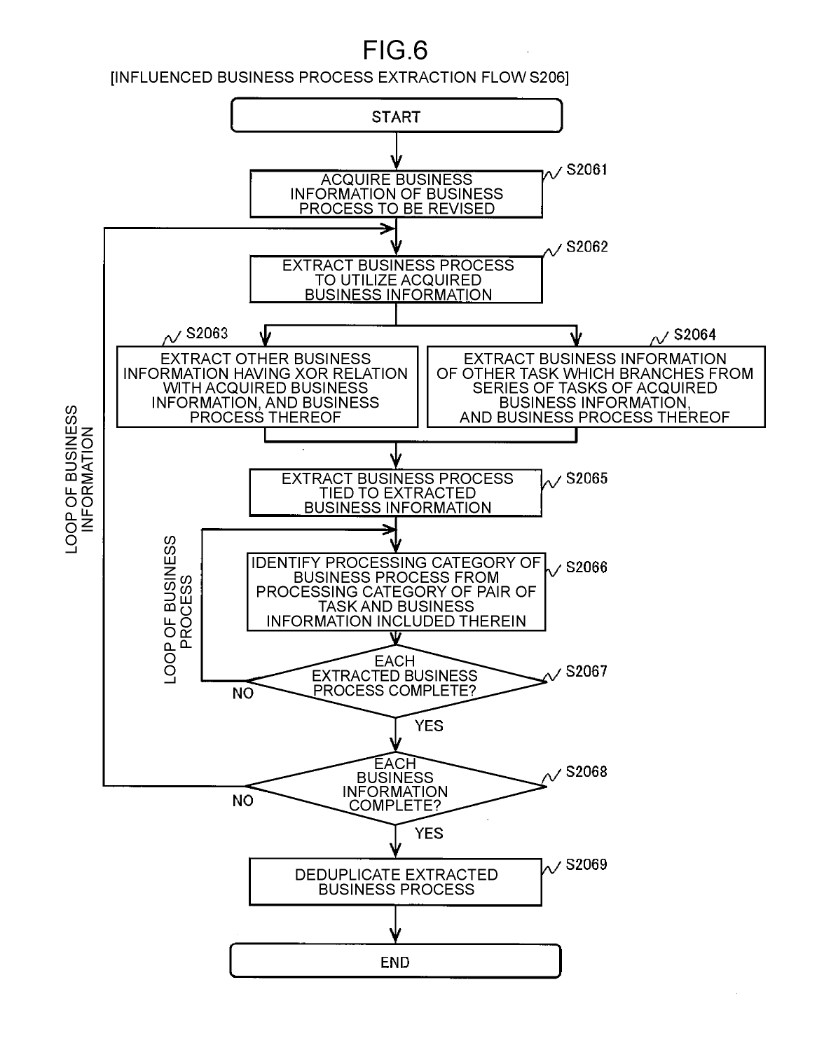

Details of processing S206 will be the processes of processing S2061 to processing S2069 in the flowchart shown in FIG. 6.

<Processing S2061>

The influence extraction unit 204 of the business process information management system 2 acquires the business information ID and the business information to be used in the business process to be revised. In this embodiment, the business information of “notification information” of the business information ID of “D002” to be used in the business process of “create notification” to be revised is acquired.

<Processing S2062>

The influence extraction unit 204 of the business process information management system 2 scans the reference business information ID of the business information information storage unit 212, identifies the business ID holding the business information ID extracted in processing S2061, and extracts the business process including the corresponding business ID. In this embodiment, the business ID of “B1-2-2” or the like holding the business information ID of “D002” extracted in processing S2061 is identified, and the business process of “create notification” including the corresponding business ID is extracted. Similarly, the business processes of “medical screening” and “correct notification” are extracted.

<Processing S2063>

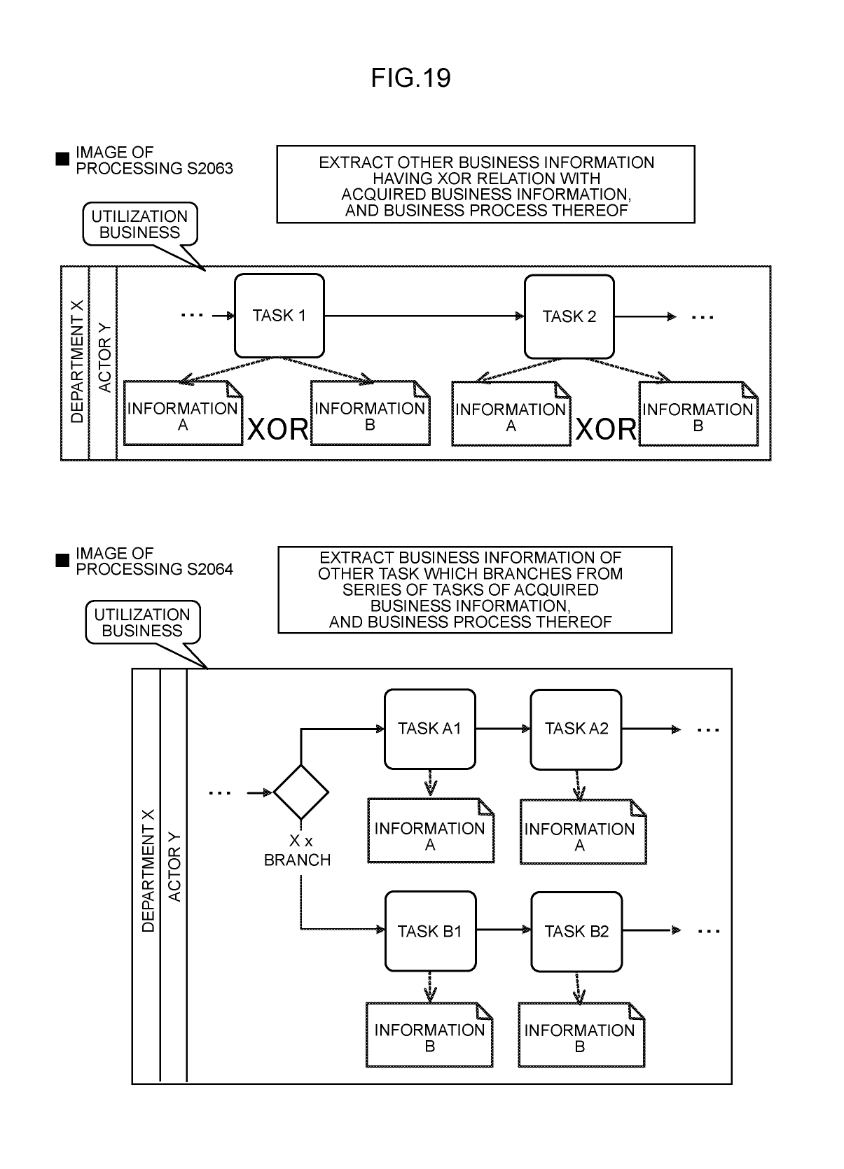

The influence extraction unit 204 of the business process information management system 2 scans the logical relation and the reference business information ID of the business information information storage unit 212, extracts the other business information ID having a logical relation of XOR with the business information ID extracted in processing S2061, identifies the business ID holding the corresponding business information ID, extracts the business process including the corresponding business ID, and thereby determines the extracted business process as the utilization business of the business variation. In this embodiment, the other business information ID of “D003” having a logical relation of XOR with the business information ID of “D002” extracted in processing S2061 is extracted, the business ID of “B1-5-1” or the like having the business information ID of “D003” is identified, the business process of “medical screening” including the foregoing business ID is extracted, and determined as the utilization business of the business variation. Note that the shape of the business process to be subject to this processing, for example, corresponds to the shape shown in “Image of processing S2063” at the upper part of FIG. 19. The upper part of FIG. 19 represents the flow that the business will be conducted of either the flow of task 1 and task 2 using information A or the flow of task 1 and task 2 using information B.

<Processing S2064>

The influence extraction unit 204 of the business process information management system 2 extracts the business information of the series of tasks using the business information ID extracted in processing S2061 as well as of the other tasks branching therefrom, and the business process using such business information, and determines the extracted business process as the utilization business of the business variation. Note that the shape of the business process to be subject to this processing, for example, corresponds to the shape shown in “Image of processing S2064” at the lower part of FIG. 19. The lower part of FIG. 19 represents the flow that the business will be conducted of either the flow of task A1 and task A2 using information A or the flow of task B1 and task B2 using information B. Note that processing S2063 and processing S2064 are performed in parallel for the optimization of the processing, and each processing advances to processing S2065 after it is completed. The term “parallel” used herein refers to processing that is performed with a different device or a different function, and the processing flows do not have to coincide temporally. Moreover, the processing may also be performed in a time series, rather than in parallel.

<Processing S2065>

The influence extraction unit 204 of the business process information management system 2 extracts the business process that is linked to the business information ID extracted in processing S2063 and processing S2064. In this embodiment, the business process of “create medical certificate” linked to the business information ID of “D003” extracted in processing S2063 and processing S2064.

<Processing S2066>

The influence extraction unit 204 of the business process information management system 2 identifies the processing category of the business process from the processing category of the pair of task and business information included for each business process with regard to the business process extracted in processing S2062 to processing S2065. In this embodiment, for example, since there are the task of “Create” and the task of “Read” in the processing category of the business information of “diagnosis information” in the business process of “create medical certificate” of FIG. 22, the two tasks of “Create” and “Read” as the processing category of the business process of “create medical certificate” and the business information of “diagnosis information”. <Processing S2067>

When the identification of the processing category of each of the extracted business processes is complete, processing S2068 is executed, and when the identification of the processing category is not yet complete, processing S2066 is executed.

<Processing S2068>

When the influence extraction of each piece of business information used by the business process to be revised, processing S2069 is executed, when the influence extraction is not yet complete, processing S2062 is executed.

<Processing S2069>

The influence extraction unit 204 of the business process information management system 2 deduplicates the business processes extracted in processing 2062 to processing 2068, creates a business variation ID, and stores the deduplicated business process in the business variation information storage unit 210. In this embodiment, the business processes of “create notification”, “medical screening”, and “correct notification” extracted in processing S2062 and the business process of “create medical certificate” extracted in processing S2066 are stored in the business process variation, the business process of “medical screening” extracted in processing S2063 and processing S2064 as the business purpose of each business process are stored in the utilization business, and the business information for each business process and the processing category of the business process identified in processing S2066 are stored.

<Processing S207>

Returning to the explanation of FIG. 3, the system-side information sending/receiving unit 201 of the business process information management system 2 sends the influenced business process information, in which the business process to be revised is excluded from the business variation information, to the business process development terminal 1. This is because the business process to be revised itself is not an influenced business process.

<Processing S105>

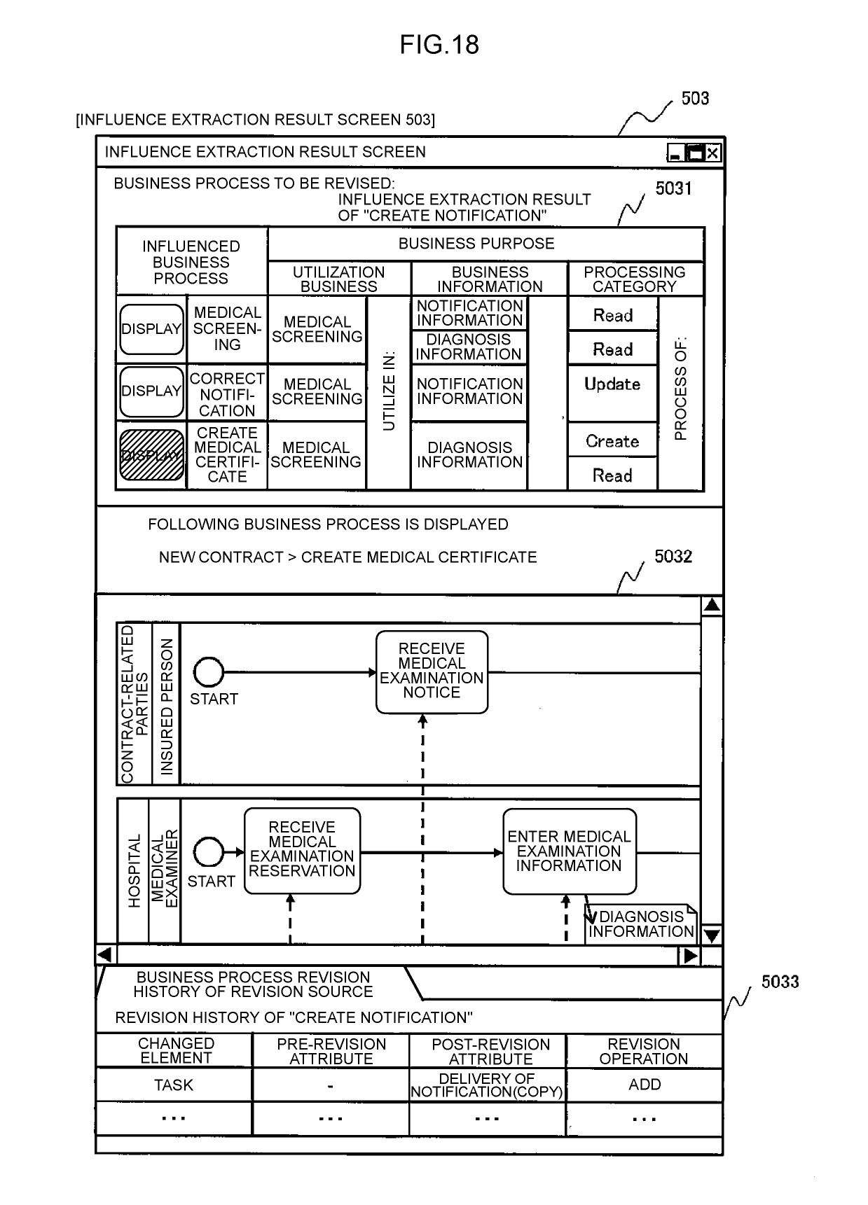

The terminal-side information sending/receiving unit 102 of the business process development terminal 1 receives the influenced business process information from the business process information management system 2, and the business process development unit 101 displays this in the influence extraction result display area 5031 of the influence extraction result screen shown in FIG. 18. Note that, in this embodiment, while the display order of the influence extraction result display area 5031 is the order of appearance of the business processes in the general process shown in FIG. 20, for instance, the business process having the same processing category as the business process to be revised may be displayed at a higher position; that is, the business process of “create medical certificate” having the same processing category as the processing category “Create” or “Read” of the business process of “create notification” to be revised may be displayed at a higher position.

<Processing S106>

The business process development unit 101 of the business process development terminal 1 receives from the business process developer the selection of the business process information to be displayed among the extraction result of the influenced business processes, and the terminal-side information sending/receiving unit 102 sends the selection reception information to the business process information management system 2. The timing of sending information shall be, for example, when the “display” button of FIG. 18 is pressed. In this embodiment, let it be assumed that the “display” button of the influenced business process of “create medical certificate” has been pressed.

<Processing S208>

The influence extraction unit 204 of the business process information management system 2 receives the selection reception information of the business process from the terminal-side information sending/receiving unit 102 of the business process development terminal 1, and acquires the revision history information of the business process to be revised from the revision history information storage unit 209.

<Processing S209>

The system-side information sending/receiving unit 201 of the business process information management system 2 sends, to the business process development terminal 1, the selected and received business process information and the revision history information of the business process to be revised acquired in processing S208. In this embodiment, the selected and received business process of “create medical certificate” and the revision history information of the business process of “create notification” to be revised are sent to the business process development terminal 1.

<Processing S107>

The business process development unit 101 of the business process development terminal 1 receives, from the business process information management system 2, the selected and received business process information, and the revision history information of the business process to be revised acquired in processing S208, and, as shown in FIG. 18, and displays the selected and received business process information in the business process editing area 5032, and displayed the revision history information of the business process to be revised acquired in processing S208 in the revision history display area 5033. The business process developer discusses with the person in charge of the business (for instance, person in charge of the business at the client corporation) regarding whether to revise the displayed business process, and revises the business process as needed.

According to this embodiment, it is possible to provide a method and a system capable of efficiently and accurately extracting the other business processes which may need to be revised due to the influence from the revision of a certain business process. It is thereby possible to optimize the development and revision of business processes. Moreover, by developing a high-quality business process which can avoid the omission of reflecting a modified business requirement, it is possible to inhibit the reworking of the system design and development of subsequent processes.

The foregoing explanation was provided for facilitating the understanding of the present invention, and is not intended to limit the present invention. It goes without saying that the present invention may be modified and improved without deviating from the gist of this invention, and also covers all equivalents of the present invention.

### REFERENCE SIGNS LIST

1: business process development terminal, 2: business process information management system, 3: communication network, 101: business process development terminal, 102: terminal-side information sending/receiving unit, 201: system-side information sending/receiving unit, 202: processing category analyzing unit, 203: difference extraction unit, 204: influence extraction unit, 205: business information logical relation extraction unit, 206: business process information registration unit, 207: business process information reading unit, 208: processing name list information storage unit, 209: revision history information storage unit, 210: business variation information storage unit, 211: task information storage unit, 212: business information information storage unit, 213: business information dictionary, 214: department/actor list information storage unit, 215: branch information storage unit, 216: connection information storage unit.

1. A business influenced part extraction method based on a business variation related to a business process, the business influenced part extraction method comprising the steps of:
associating in advance a logical relation between sets of business information used for a task in the business process;
receiving a revision of the business process;
extracting a difference between pre-revision business process information and post-revision business process information based on the received revision;
storing the difference information as revision history information of the business process to be revised;
identifying a processing category as a processing type of the business information of a pair of task and business information as constituent elements of the post-revision business process;
extracting influenced business processes from the business process information by using the revision history information, the processing category and the logical relation between the sets of business information; and
outputting the business process information of the selected business process among the extracted influenced business processes and the revision history information of the business process to be revised.

2. The business influenced part extraction method according to claim 1, further comprising the steps of:
extracting business information in which the logical relation is undefined; and
receiving an input of a logical relation of the extracted business information, and
storing the business information which has been associated with the logical relation.

3. The business influenced part extraction method according to claim 1, further comprising the steps of:
extracting a difference for each constituent element of the business process including task, branch, business information, department/actor and task order in a process of comparing and extracting a difference between the pre-revision business process information and the post-revision business process information; and
extracting a pre-revision attribute value and a post-revision attribute value of the constituent elements as the revision history information with regard to each of the extracted differences.

4. The business influenced part extraction method according to claim 1, further comprising the steps of:
determining the processing category as “Read” when an I/O relation of a pair of the task of the business process and the business information is an input relation; and
determining the processing category as “Create”, “Update”, or “Delete” from processing name list information storing a correspondence relation of a processing name and the processing category of the task in advance when the I/O relation is an output relation.

5. The business influenced part extraction method according to claim 1, further comprising the steps of:
receiving a business process to be revised, and identifying business information to be used in the business process;
extracting business information having a predetermined logical relation with the identified business information or business information to be used in a task having a predetermined logical relation with the series of tasks using the identified business information;
extracting a business process and a business variation to utilize the extracted business information;
determining whether the processing category of the extracted business process is the processing category including the pair of task and business information; and
extracting and outputting the influenced business processes by associating the influenced business processes with business process, business information, and processing category of a utilization business as the business purpose.

6. A business influenced part extraction device, comprising:
means of storing task information, business information information, business information dictionary, department/actor list information, branch information, and connection information as business process information;
means of associating in advance a logical relation between sets of business information used for a task in the business process;
means of receiving a revision of the business process, and extracting a difference between pre-revision business process information and post-revision business process information based pre-stored business process information;
means of storing the difference information as revision history information of the business process to be revised;
means of analyzing a processing category as a processing type of the business information of a pair of task and business information as constituent elements of the post-revision business process;
an influence extraction unit for extracting influenced business processes from the business process information based on the predetermined logical relation between the sets of business information or the predetermined logical relation of the series of tasks;
means of storing influenced business process information;
an input device for receiving a selection of a business process among the influenced business processes; and
means of outputting the business process information and the revision history information of the business process to be revised.

7. The business influenced part extraction device according to claim 6, further comprising:
means of extracting business information in which the logical relation is undefined based on the business information information including the logical relation between the sets of business information used in a predetermined task.

8. The business influenced part extraction device according to claim 6, further comprising:
means of extracting a difference for each constituent element of the business process including task, branch, business information, department/actor and task order in a process of comparing and extracting a difference between the pre-revision business process information and the post-revision business process information.

9. The business influenced part extraction device according to claim 6, further comprising:
means of determining the processing category as “Read” when an I/O relation of a pair of the task of the business process and the business information is an input relation for both, and determining the processing category as “Create”, “Update”, or “Delete” from processing name list information storing a correspondence relation of a processing name and the processing category of the task in advance when the I/O relation is an output relation.

10. The business influenced part extraction device according to claim 6, further comprising:
means of receiving a business process to be revised, and identifying business information to be used in the business process;
means of extracting business information having a predetermined logical relation with the identified business information or business information to be used in a task having a predetermined logical relation with the series of tasks using the identified business information;
means of extracting a business process and a business variation to utilize the extracted business information;
means of automatically determining the processing category of the extracted business process from the processing category including the pair of task and business information; and
means of extracting and outputting the influenced business processes by associating the influenced business processes with business process, business information, and processing category of a utilization business as the business purpose.
